(19) United States
(12) Patent Application Publication
(10) Pub. No.: US 2002/0032578 A1
(43) Pub. Date: Mar. 14, 2002

(54) Printing ordering method, printing ordering system and information resource adapted to be utilized in printing ordering system

(75) Inventors: Hiroyuki Fukuda, Hachioji-shi (JP); Mutsumi Kikuchi, Akishima-shi (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 09/947,243

(22) Filed: Sep. 6, 2001

(30) Foreign Application Priority Data
Sep. 11, 2000 (JP) 2000-275087

(51) Int. Cl. G06F 17/60

(52) U.S. Cl. 705/1

(57) ABSTRACT

As a request for a printing operation is input to the terminal of a publisher connected to a computer network, the server of the service providing company detects printing companies qualified to provide printed matter that meet the printing requirements as candidates. The selected candidate printing companies are rearranged according to the workload of each of the printing companies and a list of the names of the rearranged printing companies is output and displayed on the terminal of the publisher. If the publisher rejects the candidate printing companies, other candidates are listed and displayed. When the publisher's intention for placing an order with a selected printing company is made known, the server processes an agreement for the order.

### BACKGROUND OF THE INVENTION

1. Field of the Invention

This invention relates to a printing ordering method, a printing ordering system and an information resource adapted to be utilized in such a printing ordering system designed to use a computer network such as the Internet.

2. Description of the Related Art

When a publisher places an order for printing a book or some other printed matter (a publication) with a printing company, the order is often accompanied by a number of requirements to be met, including the delivery deadline and the number of copies to be printed, as well as the type of paper and the number of colors to be used.

The publisher and the printing company come to an agreement regarding the order only after the two parties have confirmed their requirements. Therefore, the sales person of the printing company is normally forced to carry out a number of troublesome tasks including having meetings with the customer (publisher), to come up with the requirements.

In recent years, a computer network service as described below has become available. The original for printing is digitized and the data on the original for printing are stored in a server of the publisher. When more copies have to be printed, the publisher retrieves the information on the layout of the publication and other matters from the server and fills in a printing order form that shows the number of copies to be printed. Then, the publisher transmits the filled in form and the data on the original for printing to the printing company via a computer network. With such a computer network service, the workload on the part of the sales person of the printing company, including that of having meetings, will be significantly reduced.

Meanwhile, as the data on the original for printing stored in the server is digital, it is therefore possible to print perfect copies of the original. Therefore, if the publisher uses another printing company to print additional copies, the former will want to make additional copies of the same quality as the first copies. Actually, this concern about the quality of printed copies has increased more than ever in recent years. Such concern is understandable because, when the sponsor of an advertisement wants to have copies of the advertisement distributed to different regions of the country, it will be advantageous for the sponsor to have local printing companies of the respective regions print copies rather than have a single printing company do so, from the viewpoint of both cost and time. However, with such an arrangement, while the time necessary down to the delivery of the copies may be shortened, there may arise a problem that the sponsor scarcely has the time necessary for confirming the quality of all the copies.

Under these circumstances, there is a strong demand for some measure or other with which people can objectively evaluate the quality of printed copies. In the field of printing, subjective assessment is still in the main stream. For instance, the factors that are taken into consideration when evaluating the quality of printed matter include positional displacement of each color and blurred dots that can degrade the image quality, in addition to ordinary factors such as density and contrast. However, since there are no established standards for assessing such factors as positional displacement and blur, they are assessed subjectively by professionals and, if there is any problem, it needs to be resolved or alleviated appropriately by regulating the printing process. Furthermore, the outcome of such regulating efforts will also be evaluated subjectively by the sponsor to be good or not good. In short, there are no established standards for the sponsor to evaluate the printed copies.

As for the actual printing of copies, each of the local printing offices selected by the sponsor starts printing after exchanging data with the latter on the basis of an agreement made between them. Then, it is necessary for the sponsor to inquire whether the data format is applicable to the printing office or not. Additionally, the sponsor will need to know the current workload of the printing office before giving instructions for the printing because the time limit of delivery may not be observed when the workload of the printing office is too heavy. In other words, it will be necessary for the sponsor to have many available printing offices listed in a file in order to get the necessary copies in time.

The original to be used for printing may arrive immediately before the scheduled start of the printing operation and requests for amending the original may often come after the start or even the completion of the printing operation. Then, the workload of the printing office can abruptly rise, particularly when the entire printing operation needs to be reconsidered. Therefore, the printing office is required to operate in a highly flexible manner, in order to accommodate such unexpected situations, otherwise, it may lose customers.

Additionally, may of the local printing companies print material for local consumption and therefore their sales activities are limited to the respective regions. In other words, they are not accustomed to do business with sponsors having nationwide demands and hence have little opportunity to get such new customers. Still further, as the number of such customers is limited and the workload of the affiliated printing offices can fluctuate from season to season, their workloads are inevitably unstable, which is financially disadvantageous.

### BRIEF SUMMARY OF THE INVENTION

In view of the above identified circumstances, it is therefore the object of the present invention to provide a printing ordering method, a printing ordering system and an information resource adapted to be utilized in such a printing ordering system with which both the publisher and the printing company receiving an order from the publisher can easily acquire information necessary for the order so that the order may be fulfilled efficiently and economically.

According to a first aspect of the present invention, there is provided a printing ordering method to be commonly used for a printed matter by a first party engaged in printing printed matters to be published and a second party engaged in publishing the printed matters by utilizing a computer network, the method comprising:

a first step for the second party to input information relating to the request for printing the printed matter including printing requirements to the terminal connected to the computer network;

a second step of detecting the first party as judged to be qualified to meet the printing requirements input in the first step from an information resource storing information relating to the first party and connected to the computer network;

a third step of outputting and displaying the information relating to the detected first party in the second step on the terminal of the second party; and

a fourth step for the second party to input finalized information to be used for selecting the first party as the order receiving party on the basis of the information relating to the first party output and displayed in the third step.

According to a second aspect of the present invention, there is provided a printing ordering system to be commonly used for a printed matter by a first party engaged in printing printed matters to be published and a second party engaged in publishing the printed matters by utilizing a computer network, the system comprising:

a terminal connected to the computer network so as for the second party to input information relating to the request for printing the printed matter including printing requirements for the printed matter; and

an information resource connected to the computer network and adapted to provide information relating to the first party to the terminal in response to the printing requirements input to the terminal; wherein

the information resource includes:

detection means for detecting the first party as judged to be qualified to meet the printing requirements on the basis of the information relating to the printing requirements input to the terminal; and

the terminal includes:

display means for outputting and displaying the information relating to the first party detected by the detection means; and

input means to be used by the second party to input finalized information to be used for selecting the first part as order receiving party on the basis of the information relating to the first party output and displayed by the display means.

According to a third aspect of the present invention, there is provided an information resource to be utilized in a printing ordering system commonly used for a printed matter by a first party engaged in printing printed matters to be published and a second party engaged in publishing the printed matters by utilizing a computer network, the information resource being connected to the computer network, the information resource comprising:

means for receiving information relating to the request for printing the printed matter including printing requirements for the printed matter from the terminal connected to the computer network and used by the second party to input the printing requirements;

means for detecting the first party as judged to be qualified to meet the printing requirements on the basis of the information relating to the printing requirements input to the terminal; and

means capable of providing information relating to the first party to the terminal by way of the computer network.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate a embodiment of the invention, and together with the general description given above and the detailed description of the embodiment given below, serve to explain the principles of the invention.

FIG. 1 is a chart schematically illustrating the relationship of a publisher, a printing company and a printed matter by means of the ERD symbol system;

FIG. 2 is a flow chart of the operation of an embodiment of a printing ordering system according to an embodiment of the invention where various attribute data of printing companies are stored on a company by company basis in a data base that is an information resource connected to a computer network such as the Internet, and is available when the publisher places an order with one of the printing companies;

FIG. 3 shows tables that can be used in a data base for an operation as shown in FIG. 2;

FIG. 4 shows tables that can be used in a data base to show the breakdown of the assessment of a printed matter prepared at the time of order placement;

FIG. 5 shows tables that can be used in a data base at the time of an actual printing operation;

FIG. 6 is a schematic illustration of a remote-access order data base, connected, via the Internet, to a publisher and a printing company;

FIG. 7 is a schematic illustration similar to FIG. 6 but showing a situation where the printing company has its own data base;

FIG. 8 is a flow chart of an operation conducted by both a publisher and a printing company for checking the appropriateness of a printing operation to be carried out by the printing company according to an order placed by the publisher;

FIG. 9 is a schematic illustration of a quantitative requirements input screen to be displayed on the monitor screen of the terminal of a publisher when the publisher finishes entering quantitative requirements;

FIG. 10 is a schematic illustration of a qualitative requirements input screen to be displayed to prompt inputs of qualitative requirements;

FIG. 11 is a schematic illustration of the operation of an order data base when detecting appropriate printing companies on the basis of requirements; and

FIG. 12 is a schematic illustration of a detection result display screen to be displayed on the monitor screen of the terminal of a publisher for information on the printing companies selected as a result of a final screening operation using an order data base.

### DETAILED DESCRIPTION OF THE INVENTION

Now, the present invention will be described by referring to the accompanying drawings that illustrate an embodiment of the invention.

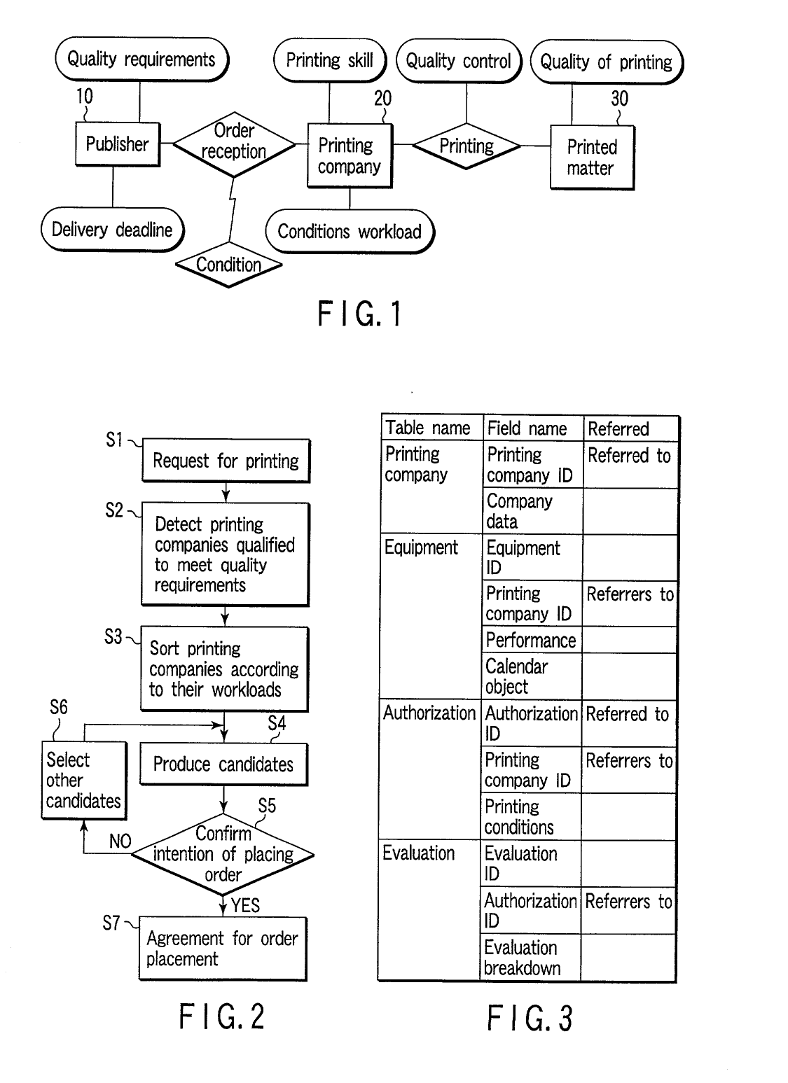

FIG. 1 is a chart schematically illustrating the relationship of a publisher 10, a printing company 20 and a printed matter 30 by means of the ERD symbol system. They are indicated by respective boxes, each denoting “a person or object”, using ERD symbols. Their “relations” as viewed from the printing company 20 are indicated by rhombuses. Additionally, they have “attributes” indicated by respective ellipses.

The attributes of the publisher 10 include “quality requirements” and “delivery deadline” that relate to information on the order for the printed matter 30. These requirements of the publisher 10 demanded of the printing company 20 indicate the level of work to be achieved as a whole.

The printing company 20 who needs to meet the requirements has an attribute of “printing skill” to be used as information for determining if the printing company 20 can ensure the required quality level or not and that of “conditions workload” to be used as information for determining if the printing company 20 can deliver before the deadline.

When the two parties come to an agreement, the order is placed and the printing company 20 starts operations for the printed matter 30.

The operations of printing have an attribute of “quality control” and the printed matter 30 itself has an attribute of “quality of printing”.

Now, each of the above attributes will be briefly described below.

The requirements for the printing produced by the publisher 10 contain information representing the resolution of the printed matter 30, information indicating if the printed matter 30 is in color or in monochrome and information on the type of paper to be used for the printing and the cutting operation after the printing.

The attribute “conditions workload” of the printing company 20 refers to information regarding the printing machine available for the printing operation, and whether the operation can be completed by the delivery deadline or not, and the number of workers available for the printing operation.

The attribute “printing skill (printing technology)” of the printing company 20 refers to information of whether the company possesses the machines and skills necessary to meet the printing requirements or not. More specifically, it refers to information on the performance and the specification of the printing machine to be used for the printing and if the printing skill is authorized publicly or privately.

The attribute “quality control” for the printing operation refers to the value of objective rating obtained by following a quality control procedure or by referring to a work standard provided by the printing company 20.

The copies of the printed matter 30 that are to be delivered have their attribute of “quality of printing” that shows the quality level of the products.

The relationship between the “quality control” of the printing operation and the “quality of printing” of the produced copies of the printed matter 30 will be briefly discussed below.

The “quality control” of the printing operation is checked typically by a sampling test that is conducted during the printing operation. Not all the copies are checked for “quality of printing”. Therefore, they are strongly correlated but may not completely agree.

For the purpose of improving the correlation, a process assurance concept that the “right products are produced from the right process” has been introduced in the industry. Most printing offices are currently trying to ensure a high quality level by rigorously defining the printing process.

For the “quality control” of the printing operation, the stability of performance of the printing machine needs to be assessed. In other words, when the required “quality of printing” is high, a high performance printing machine has to be selected and the printing operation has to be checked frequently for a large number of check items.

The “quality of printing” may include the level of achievement that is judged subjectively and cannot be expressed by an objective rating system.

The level of achievement may refer to the appearance of the colors checked in the color proof and/or the richness of the printed copies and hence has to be checked by the publisher 10 by proof printing, which is an operation comparable to registering.

FIG. 2 is a flow chart of the operation of this embodiment of a printing ordering system according to an embodiment of the invention wherein various attribute data of printing companies are stored on a company by company basis in a data base that is an information resource connected to a computer network such as the Internet and is available when the publisher 10 places an order with one of the printing companies 20. While such a data base is normally arranged in an independent service providing company (not shown), the publisher 10 may have its own data base.

Referring to FIG. 2, as a request for copies of a printed matter 30 is made by the publisher 10 by way of the terminal (not shown) of the publisher 10 connected to the computer network (Step S1), the server (not shown) of the service providing company detects printing companies 20 that can meet the quality requirements of the publisher 10 from the data base (Step S2). The information on the authorized printing skill (printing technology) of each of the printing companies is utilized in this step.

The server of the service providing company sorts the detected printing companies 20 on the basis of their respective workloads, in order to judge if they can meet the delivery deadline or not (Step S3). The delivery deadline is one of the printing requirements to be met.

Then, the server outputs and displays the sorted candidate printing companies 20 on the terminal of the publisher 10 that produced the printing requirements (Step S4) and asks to confirm the order (Step S5).

If any of the currently displayed candidates is not accepted by the publisher 10, other candidates are selected (Step S6) and the processing operation returns to Step S4 to display the newly selected candidates. Detailed data including the estimated cost of the printing operation will be displayed with the candidates.

When the publisher 10 selects one of the candidates and wants to place an order with the selected printing company, the publisher 10 confirms the order in Step S5 by way of keyboard input, at the terminal, to conclude the agreement on the order (Step S7).

FIG. 3 shows tables that can be used in the data base for the above operation.

The leftmost column of the tables in FIG. 3 shows the table names and the middle column shows the field names contained in the tables, while the rightmost column shows the references, indicating the same field names shared by some of the tables. In other words, each of the records of the referring side and the corresponding record of the referred side are correlated by the value of the related field.

Firstly, four tables are provided for the printing companies. They include “printing company”, “equipment”, “authorization” and “evaluation”.

Each of the tables contains a main key field having a field name+ID to be used for controlling the records contained therein on the data base, the field name being the same as the table name.

The “printing company” table has two fields: “printing company ID” to be used as main key and “company information”.

The “equipment” table has an “equipment ID” field to be used as a main key, a “printing company ID” field to be used for referring to the printing company table, a “performance” field showing the performance of the equipment and “calendar object” field showing the workload of the equipment. The “calendar object” field contains the schedule of operation and that of maintenance of the equipment in units of hours.

The “authorization” table has an “authorization ID” field to be used as a main key, a “printing company ID” field and a “printing condition” field showing the authorized printing conditions.

The “evaluation” table has an “evaluation ID” field to be used as a main key, an “authorization ID field” to be used for referring to the authorized printing conditions and an “evaluation breakdown” field showing the evaluation system.

When detecting companies that can meet the quality requirements shown in Step S2 above from the data base, the “printing condition” field of the “authorization” table is used. Thus, the printing companies 20 that are authorized for the printing conditions that meet the quality requirements are detected. When the quality requirements are described in terms of an objective rating system, candidate printing companies can be detected by the “evaluation breakdown” field of the “evaluation” table for evaluating the record and by referring to the record of the “authorization” table by the authorization ID for the result of the detection.

When sorting the candidate printing companies 20 on the basis of the workload of each of the companies in Step S3, the record containing the “printing company ID” of each of the printing companies obtained as a result of the above detection is retrieved from the “equipment” table and the “calendar object” of each of the companies of the record is checked to obtain information on the workload of the equipment of the company, and assess the availability of the equipment until the delivery deadline. At this time, the equipment is checked to see if its performance can meet the quality requirements.

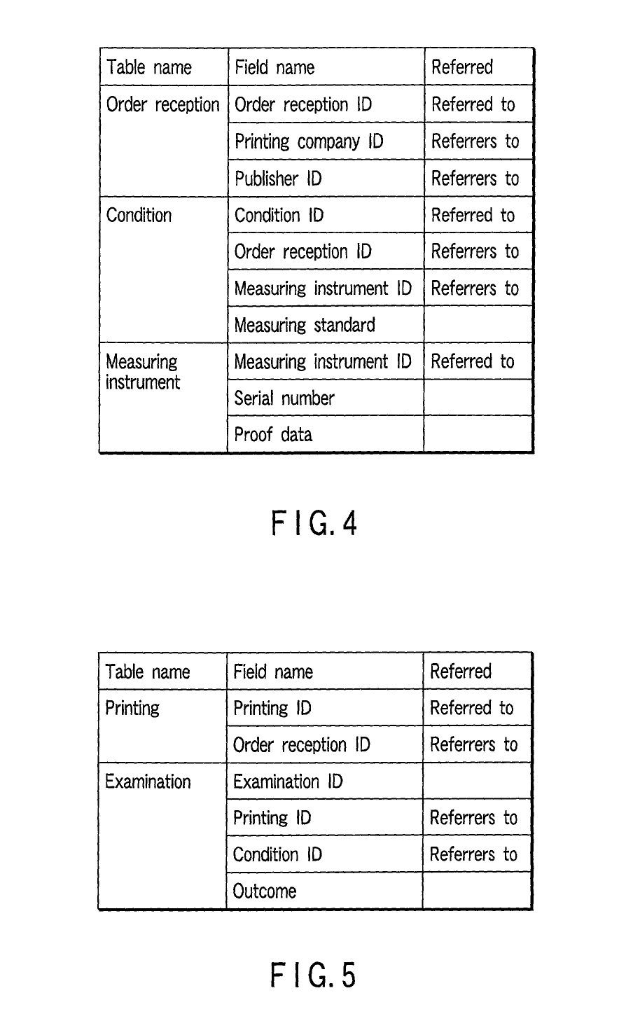

When the publisher 10 and the selected printing company 20 come to agreement on the order, a record that corresponds to a letter of specifications and contains requirements for the printing is prepared. The record contains the evaluation breakdown and the specified values to be used for the printed matter. Thus, the data base contains tables as shown in FIG. 4.

Referring to FIG. 4, the “order reception” table contains an “order reception ID” field to be used as a main key, a “printing company ID” field and a “publisher ID” field.

The “condition” table describing the conditions of the order contains a “condition ID” field to be used as a main key, an “order reception ID” field to be used for referring to the “order reception” table, a “measuring instrument ID” field to be used for referring to the measuring device and a “measuring standard” field to be used for the measuring instrument.

The “measuring instrument” table contains a “measuring instrument ID” field to be used as a main key, a “serial number” field and a “proof data” field.

As will seen from the above described structure of the data base, an order is normally accompanied by more than one condition and hence there can be a plurality of records having the same condition ID that is used for minutely defining the printing quality.

The information on the measuring instruments preferably contains all the necessary data concerning the level of accuracy of each measurement item and so on. Then, a table has to be added for each item.

Now, the tables to be used in an actual printing operation will be described below.

There are two tables to be used in an actual printing operation including a “printing” table and an “examination” table as shown in FIG. 5. The “printing” table contains a “printing ID” field to be used as a main key and an “order reception ID” field showing the received orders. The “examination” table is used to store the results of the examination conducted during the printing operation and contains an “examination ID” field to be used as a main key, a “printing ID” field showing the relationship with the “printing” table, a “condition ID” field for specifying a particular examination item and an “outcome” field for storing the results of the examination.

The relationship between FIG. 4 and FIG. 5 will summarized here. The “condition” table of FIG. 4 shows all the quality requirements specified at the time of receiving the order. More specifically, it specifies the measuring instrument and the measuring process. On the other hand, the table of FIG. 5 shows the correlation with the “order reception” table so that all the quality requirements specified at the time of receiving the order are defined again at the time of the printing operation. All the condition items are checked by way of actual measurements before the shipment, because the printed copies cannot be shipped without such measurements. The results of the examination are entered in the “examination” table. At this time, each entered data item relates to the relevant examination item by using the condition IDs.

Now, the process of examining the printed copies of the printed matter 30 will be described by way of an example.

The image density of a printed matter 30 can be measured typically by a densitometer. Densitometers adapted to measure the area ratio of a dot image are known. The area ratio is specific to dot images and hence can be used to evaluate them. It is actually utilized in printing offices for the purpose of quality control.

U.S. Pat. No. 6,050,731 proposes a method of measuring the amount of errors contained in a dot code from the printed image of the code. Dot codes often have a degree of fineness close to the limit of the printing resolution and the amount of errors contained in a dot code can vary depending on the degree of perfection of the printing. Therefore, with the method disclosed in the above patent document, the error rate that represents the quality of the code is determined by measuring the degree of perfection and used as an index indicating the quality of the printing. Particularly, in the case of printing a dot code, the method of using the error rate of the code as an index is very effective.

Nevertheless, such an examination is conducted in the process of printing copies of the printed matter and the result of the examination can be used to objectively assess the printing skill of the printing company. As pointed out above, the error rate changes as a function of the degree of perfection of the printing and therefore it is possible to determine the level of control of printing quality of the printing company 20 by observing the changes in the error rate. For example, when printing 10,000 copies of a printed matter, the error rate may be measured after printing every 500 copies to see the changes in the error rate. If it is found that the error rate increased significantly after printing 3,000 copies, it is safe to assume that the image of the copies had been damaged by paper dust. If, on the other hand, a printing company 20 that can reliably control problems, such an increase in the error rate would not occur because the company would have been able to take effective measures for eliminating the problem.

Additionally, the level of printing skill of a printing company 20 can be determined if the average error rate of dot codes is known for ordinary printing operations.

In short, by assessing the printing skill of each printing company 20, using an objective means, the levels of image quality control of various printing companies can be expressed in the same terms.

The level of printing skill and that of quality control of a printing company 20 may be authorized if the company does not use the above described method of controlling the error rate of dot codes.

For example, the acquisition of the ISO90000 series or the qualification of DTP (desk top publishing) expert of the Japan Printing Technology Institute may also be used for authorization.

The staff member of a printing company 20 who is qualified as a “IDTP expert” for the ability of preparing an original plate to be used for printing by DTP technology may be registered in the data base. Then, when a request for a DTP operation is issued from a publisher 10, printing companies having such a staff member will be detected in the data base. Thus, this system can be used to provide not only simple printing services but also broader services relating to printing.

Now, how the data base is accessed by way of a computer network will be described by referring to the related drawings.

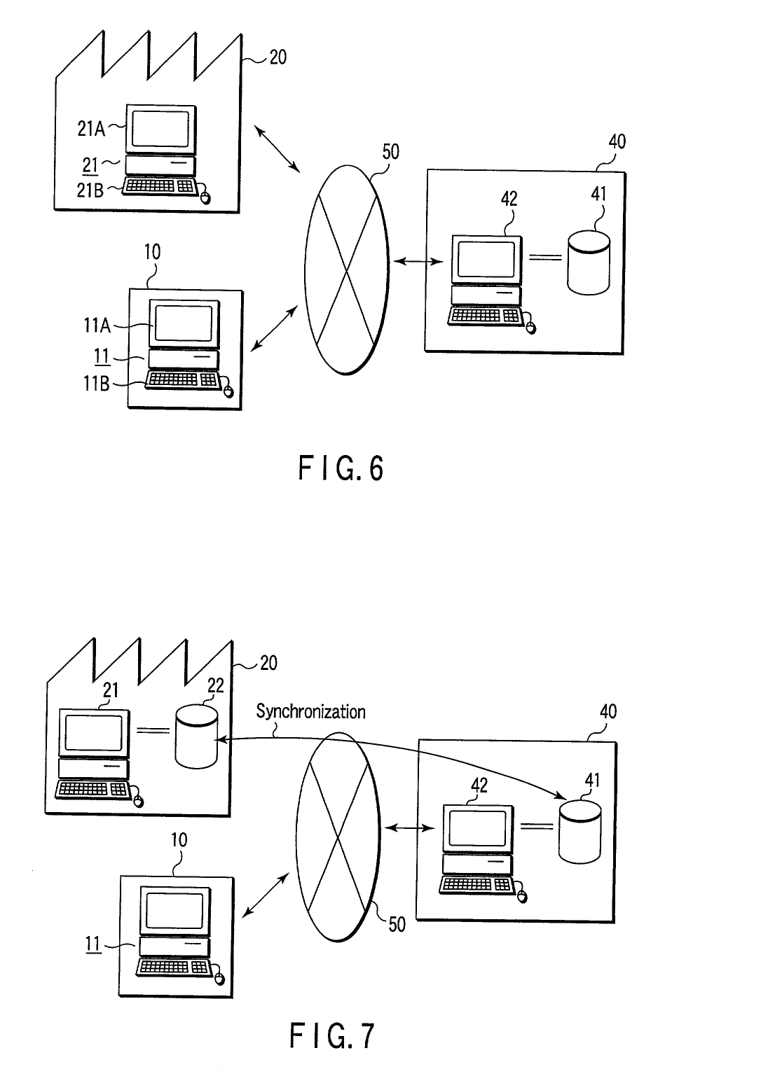

FIG. 6 is a schematic illustration of access to an order data base 41 from a publisher 10 and a printing company 20 that are remote from each other by way of the Internet 50. To be more accurate, the order data base 41 is arranged in a service providing company 40 and the server 42 of the service providing company 40 accesses the order data base 41 in response to the request for access of the publisher 10 and that of the printing company 20 and transmits the requested respective data to the publisher 10 and the printing company 20. While only a single publisher 10 and a single printing company 20 are illustrated in FIG. 6, in reality a number of companies are connected to the data base by way of the Internet 50.

The calendar object describing information on the workload and the schedule of operations of the printing company 20 is stored in the order data base 41 that is remote from the printing company 20. Therefore, the printing office of the printing company 20 does not need to be provided with a computer for the data base and can operate without any problem provided it has a terminal 21 through which the staff of the printing office can access the remote data base. Note that each of the terminal 21 comprises a display 21A such as a CRT display and an input device 21B such as a combination of a keyboard and mouse.

The publisher 10 also can operate without any problem provided it has a terminals 11 (comprising a display 11A and an input device 11B) through which any of the staff of the publisher 10 can issue a request for printing to the remote data base and display the outcome of the retrieving operation obtained for the request by the data base engine of the server 42. Therefore, the publisher 10 too does not need any heavy equipment.

FIG. 7 is a schematic illustration similar to FIG. 6 but showing a situation where the printing company 20 has its own data base.

With the arrangement of FIG. 7, however, the data base 22 of the printing company 20 has to be appropriately synchronized for operation with the order data base 41. Assume that the running condition of the printing equipment of the printing company 20 is controlled by the data base 22 of the printing company 20 and the data base 22 is not synchronized for operation with the order data base 41. Then, when a request for a printing operation is issued from the publisher 10, the server 42 will select candidate printing companies on the basis of the running condition of the printing equipment of the printing company 20 as stored in the order data base 41 so that the printing company 20 may be selected as one of the candidates although the schedule of operations of the printing company 20 has no room for receiving the order and the records having a same main key value in the two data bases may be modified in different ways to give rise to so-called “contradictory” states.

Therefore, it is necessary to “synchronize” the two data bases for operation in order to eliminate such problems. Such a synchronizing operation is typically conducted by checking the data bases for alterations, if any, since the last synchronizing operation and, if one or more than one alteration is detected, replacing the old data by the corresponding new data.

The synchronizing operation may be carried out by using a dedicated line or by the Internet 50 as in the case of FIG. 6.

Nevertheless, no order can be placed by means of the order data base 41 unless the two data bases are synchronized. Therefore, the server 42 of the service providing company 40 needs to start the operation of synchronizing the order data base 41 with the data base 22 each time a request for printing is issued if the two data bases are not synchronized and start the operation of detecting candidate printing companies only when the former operation is completed.

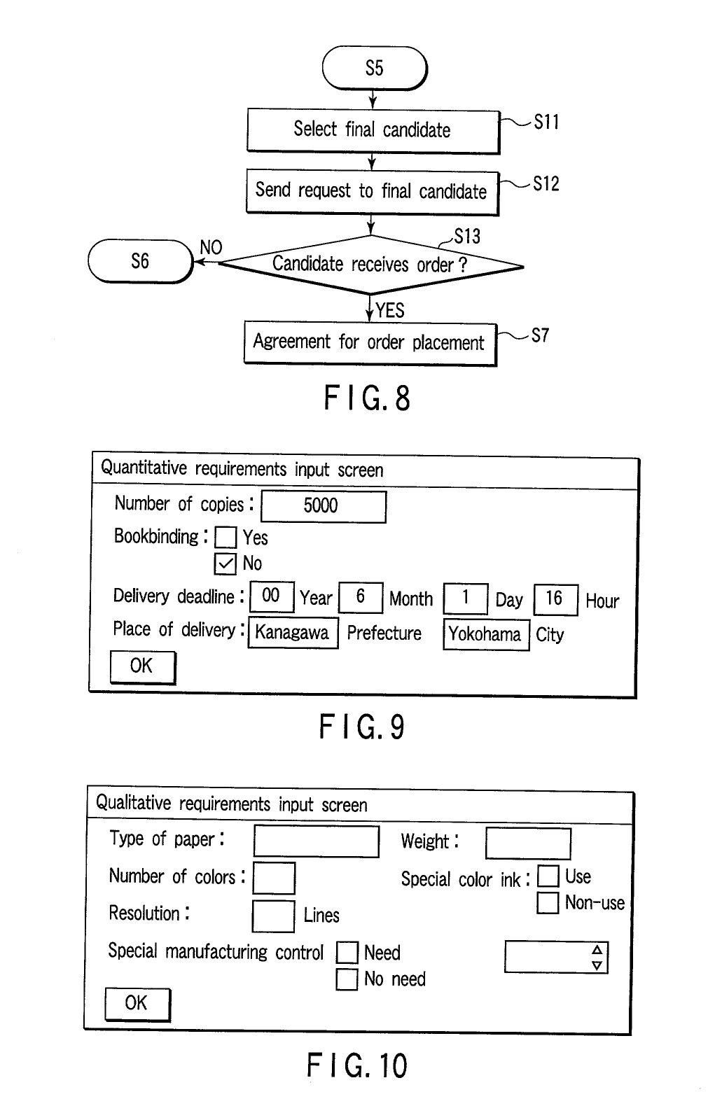

Additionally, since the appearance of “contradictions” cannot be avoided perfectly by the synchronizing operation, it is desirable for both the publisher and the printing company to check the appropriateness of respectively placing and receiving the order in a manner as shown in FIG. 8.

The procedure down to the step of selecting a printing company 20 meeting the requirements of the publisher 10 is described earlier by referring to FIG. 2. Now, the procedure by which both the publisher 10 and the printing company 20 make efforts to reach an agreement will be described below by referring to FIG. 8. Note that the steps of FIG. 8 are supposed to be added between Step S5 and Step S7 in FIG. 2 and hence the steps in FIG. 8 that are the same as their counterparts in FIG. 2 will not be described any further.

When the order of the publisher 10 is confirmed in Step S5, the server 42 determines the printing company 20 with which the publisher 10 wants to place the order as final candidate printing company (Step S11). Then, the server 42 notifies the printing company 20 of the fact that a request for printing has been issued from the publisher 10 (Step S12).

The printing company 20 decides if it will receive the order or not in response to the request and notifies the server 42 of its decision by way of the terminal 21. If the server 42 receives a notification that the printing company 20 has decided to receive the order (Step S13), it proceeds to Step S7 for an agreement. If, on the other hand, the server 42 receives a notification that the printing company 20 has decided that it will not receive the order, the server 42 proceeds to Step S6, where it selects another candidate.

This procedure for confirmation not only avoids contradictions among data bases but also raises the degree of freedom of selecting a printing company for the publisher 10. For instance, the publisher 10 may preferentially place the order with a printing company 20 that has worked for the publisher 10 for a number of times and hence has a close relationship with it.

It is also possible to make the data base store information on the business relationship between the publisher 10 and each printing company so that the affiliate printing companies having close ties with the publisher 10 may be preferentially selected as candidates.

Now, a situation where a plurality of printing companies 20 are selected as candidates for receiving an order will be described below.

There may be not few occasions where the original needs to be replaced after the printing operation has started so that the schedule for printing copies of the original has to be changed. In order to respond quickly to such a situation, there has been a strong demand for the provision of a list of alternative printing companies to accommodate such an urgent situation as a change in the schedule.

According to the invention, when selecting one or more than one candidate printing companies in Step S2 of FIG. 2, the schedules of all the printing companies in the data base are checked for the expected date of printing and days before and after that date to select auxiliary candidate companies that can respond to such a changed schedule.

The auxiliary candidate companies may or may not include some of the proper candidate companies. Therefore, some of the auxiliary candidate companies may not receive the order after all. While such auxiliary candidate companies are identified in the order data base 41, they will not be notified of anything about the order until the original schedule for printing is urgently changed for some reason or another.

Then, each of such auxiliary candidate printing companies will be selected by referring not only to the workload of the equipment and the information on authorization of skill of the company, which are described earlier, but also to the readiness of the company for responding to urgent situations.

For instance, such auxiliary candidate companies need to be able to carry out the pre-press operation from the time of receiving the electronic data on the original by way of the network to the time of making a plate for the original in a short period of time. Therefore, the auxiliary candidate company may typically be required to have DTP-related abilities including the technology and equipment for converting the data of the original prepared by the proper candidate printing company into those adapted to the output apparatus of its own.

Now, the images that are typically used for input operations at the terminal 11 of the publisher 10 will be described.

Firstly, a quantitative requirements input screen for inputting quantitative requirements for producing copies of the printed matter is displayed on the terminal 11 of the publisher 10.

FIG. 9 is a schematic illustration of a quantitative requirements input screen to be displayed on the monitor screen of the terminal of a publisher when the publisher finishes entering quantitative requirements. Assume that “5,000” is input as number of copies to be produced for the printed matter 30 and the fact that no operation of bookbinding is required is input by clicking the “no” box (if the “yes” box clicked, a box for prompting an input for the format will appear). Furthermore, the time and date of the “16-th” hour, the “1-st” day, the “6-th” month and the year “00” are input for the deadline of delivery and “Yokohama” City and “Kanagawa” Prefecture are input for the place of delivery.

when the input operation is completed, the OK button at the lower left corner of the input screen is clicked. Then, a qualitative requirements input screen for prompting inputs of qualitative requirements as shown in FIG. 10 is displayed. The qualitative requirements input screen of FIG. 10 represents a blank form that contains the following:

items for the type and the weight per unit sheet necessary for specifying respectively the type of paper and the height of the printed matter 30,

an item for specifying the number of colors indicating if the printing is in color or in monochrome,

check boxes for specifying the use or non-use of special color ink for the printed color,

an item for specifying the resolution,

check boxes for specifying the need or not of a special manufacturing control system required for the printing, such as bar codes or dot codes,

a pull down menu for selecting items relating to the manufacturing control system if the box for the need of a special manufacturing control system is clicked.

The items that can be selected by the pull down menu may include one for finding out if the authorization of an external authority is obtained for printing skills or not and the one for requesting a quality inspection to be performed on all the copies.

The input operation for the qualitative requirements is completed when all the items are clicked and subsequently the OK button is clicked as in the case of the input operation for the quantitative requirements.

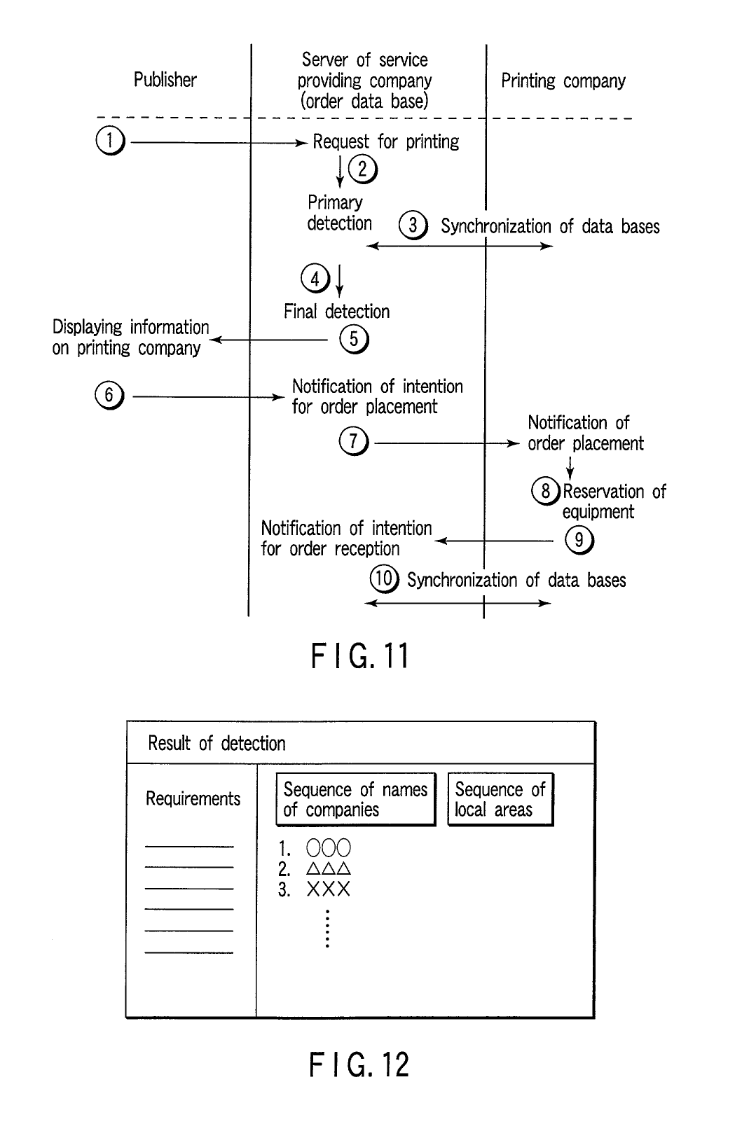

Now, the operation of the server 42 of the service providing company 40 for detecting candidate printing companies on the basis of the above requirements will be described by referring to FIG. 11.

\mathring{1} Firstly, the server 42 receives a request for printing from the terminal 11 of the publisher 10 by way of the Internet 50.

\mathring{2} Then, the server 42 detects the printing companies of a limited area from the order data base 41 on the basis of the information on the place of delivery. While the information on the place of delivery may normally be detected by referring to the information on the printing companies stored in the data base 41, the server 42 is so adapted as to also detect printing companies capable of delivering the finished copies of the original to the specified place of delivery on the basis of the equipment information if the company is located relatively remote from the place of delivery. Then, the candidate companies will be checked further in terms of the need for a special manufacturing control system, which is one of the qualitative requirements, to select the primary candidate companies as a result of the above screening operations.

\mathring{3} The server 42 synchronizes the local data base 22 of each of the primary candidate companies with the order data base 41 by way of the Internet 50 (or a dedicated line) in order to eliminate any contradictions. Care should be taken so that the local data base 22 of each of all the primary candidate companies is synchronized with the order data base 41 without fail.

\mathring{4} Then, if the type of paper and/ or the number of colors is specified, the server 42 checks if the equipment of each of the primary candidate companies is qualified for each of the specified items by referring to the order data base 41 and, if qualified, confirms whether the qualified equipment is available for the time period necessary for producing the expected copies of the original. Then, the final candidate companies are selected as a result of the above final detection operation.

\mathring{5} The server 42 transmits the information on the final candidate companies selected as a result of the above final detection operations to the terminal 11 of the publisher 10 that issued the request by way of the Internet 50 and causes the terminal 11 to display the information.

\mathring{6} Upon receiving the information, the publisher 10 expresses its intention of placing the order for printing copies with the final candidate companies, which is then transmitted to the server 42 by way of the Internet 50.

\mathring{7} While it may be so arranged that the publisher 10 and the final candidate companies automatically come to an agreement for the order at the time when the intention is expressed, it is better for both parties that the final candidate companies 20 are notified of the order placement by way of the Internet 50.

\mathring{8} In response to this notification, the data base 22 of each of the selected printing companies 20 preliminarily records the schedule of the expected printing operation for the received order in the calendar object of the equipment table in order to reserve the equipment for the order.

As a result, the printing companies 20 can prepare the schedule for the printing operation without any manual work.

\mathring{9} Thereafter, the printing companies 20 formally confirm that they receive the order and will observe the deadline and the place of delivery to the data base 41.

\mathring{10} As a result, the server 42 requests each of the printing companies 20 to synchronize the calendar object of the data base 22 of the printing company 20 with that of the order data base 40 by way of the Internet 50. Then, the preliminarily recorded schedule on the part of the printing company 20 is transmitted to the server 42 by way of the Internet 50 and finalized.

FIG. 12 is a schematic illustration of an image to be displayed on the monitor screen of the terminal 11 of the publisher 10 for information on the printing companies selected as a result of the final detection operation on using an order data base.

Referring to the image of FIG. 12, the printing requirements of the order are listed along the left side of the image and the printing companies selected as a result of the final detection operation are listed to the right.

The printing companies may be arranged in alphabetical order or alternatively in the order of local areas where the printing companies are located. The arrangement of the printing companies may be changed by clicking the button disposed on top of the printing companies.

Although omitted from the figure, information on each of the selected printing companies that is recorded in the data base including the address, the e-mail address, the telephone number, etc. of the company is also shown in the detection result display screen.

It is also possible to display the mark given to the printing skill of each of the selected printing companies by an objective rating system.

The agreement for the order may be input by clicking desired one of the displayed printing companies by a mouse at the terminal 11.

While the present invention is described in detail above by way of an embodiment thereof, the present invention is by no means limited to the described embodiment, which may be modified or applied in various different ways without departing from the scope of the invention.

For instance, the publisher 10 in the above described embodiment may be replaced by a firm specializing in planning printed matters 30. For instance, it may be replaced by a newspaper company or a company specializing in designing advertisement leaflets that may be distributed with newspapers.

While the network is a wide computer network such as the Internet 50 in the above description, it may be replaced by a system by means of which the data base is directly accessed from terminals by way of telephone lines.

The present invention will be summarily described below.

(1) A printing ordering method to be commonly used for a printed matter by a first party engaged in printing printed matters to be published and a second party engaged in publishing the printed matters by utilizing a computer network, the method comprising:

a first step for the second party to input information relating to the request for printing the printed matter including printing requirements to the terminal connected to the computer network;

a second step of detecting the first party as judged to be qualified to meet the printing requirements input in the first step from an information resource storing information relating to the first party and connected to the computer network;

a third step of outputting and displaying the information relating to the detected first party in the second step on the terminal of the second party; and

a fourth step for the second party to input finalized information to be used for selecting the first party as the order receiving party on the basis of the information relating to the first party output and displayed in the third step.

With this arrangement, when a publisher intending to publish printed matter places an order for printing copies of the printed matter with a printing company, the publisher can easily detect a printing company that is qualified and can meet the printing requirements of the publisher by means of a computer network so that the publisher can place the order for printing copies of the printed matter with the printing company efficiently and economically to a great advantage of the both parties.

(2) The method according to (1), wherein

the information resource contains a data base storing attribute information relating to the printing ability specific to each of a plurality of candidate first parties; and

the first party is detected in the second step from the data base on the basis of the attribute information and the information relating to the input printing requirements.

This arrangement provides an additional advantage in that a desired printing company can be selected from a plurality of candidate printing companies on the basis of the printing ability of each of the candidate printing companies, in addition to the advantages of (1) above.

(3) The method according to (1) or (2), further comprising:

a fifth step of mutually confirming the order for the printing between the terminal of the second party and that of the selected first party after selecting the first party in the fourth step.

This arrangement provides an additional advantage in that both the publisher and the selected printing company can mutually confirm the conditions for the operation of printing copies of the printed matter at the time of order placement to eliminate any possible cross-purposes that can arise between the publisher and the printing company in the future, in addition to the advantages of (1) and (2) above.

(4) The method according to (2), wherein

a local data base of each of the first parties storing the attribute information of the first party is connected to the computer network; and

the detecting operation of the second step is started after the data base is synchronized with each of the local data bases in response to the input of information relating to the printing requirements in the first step.

This arrangement provides an additional advantage in that any possible cross-purposes that can arise between the publisher and the printing company can be eliminated in advance and the publisher can always obtain updated information relating to the printing companies because the data base is synchronized with each of the local data bases before the detecting operation, in addition to the advantages of (2) above.

(5) The method according to one of (2) to (4), wherein the attribute information includes at least one of information relating to the printing skill specific to each of the printing companies of the first party and information relating to the printing workload of each of the printing companies of the first party.

This arrangement provides an additional advantage in that the basic questions of the publisher including “if the required level of printing quality is ensured” and “if the delivery deadline is observed” can be answered because information relating to the printing skill specific to each of the printing companies and the printing workload of each of the printing companies is stored in the data base, in addition to the advantages of (2), (3) and (4) above.

(6) The method according to one of (1) to (5), wherein

the information relating to the printing requirements input in the first step include at least one of information relating to the quality requirements of the printed matter and information relating to the delivery deadline of the copies of the printed matter.

This arrangement provides an additional advantage in that the publisher can specify the basic questions of the publisher including “if the required level of printing quality is ensured” and “if the delivery deadline is observed” as conditions for detection when the publisher detects a desired printing company, in addition to the advantages of (1), (2), (3), (4) or (5) above.

(7) A printing ordering system to be commonly used for a printed matter by a first party engaged in printing printed matters to be published and a second party engaged in publishing the printed matters by utilizing a computer network, the system comprising:

a terminal connected to the computer network so as for the second party to input information relating to the request for printing the printed matter including printing requirements for the printed matter; and

an information resource connected to the computer network and adapted to provide information relating to the first party to the terminal in response to the printing requirements input to the terminal; wherein

the information resource includes:

detection means for detecting the first party as judged to be qualified to meet the printing requirements on the basis of the information relating to the printing requirements input to the terminal; and

the terminal includes:

display means for outputting and displaying the information relating to the first party detected by the detection means; and

input means to be used by the second party to input finalized information to be used for selecting the first part as order receiving party on the basis of the information relating to the first party output and displayed by the display means.

With this arrangement, when a publisher intending to publish a printed matter places an order for printing copies of the printed matter with a printing company, the publisher can easily detect a printing company that is qualified and can meet the printing requirements of the publisher by means of a computer network so that the publisher can place the order for printing copies of the printed matter with the printing company efficiently and economically to a great advantage of the both parties.

(8) The system according to (7), wherein

the information resource contains a data base storing attribute information relating to the printing ability specific to each of a plurality of candidate first parties; and

the detection means detects the first party from the data base on the basis of the attribute information and the information relating to the input printing requirements.

This arrangement provides an additional advantage in that a desired printing company can be selected from a plurality of candidate printing companies on the basis of the printing ability of each of the candidate printing companies, in addition to the advantages of (7) above.

(9) The system according to (7) or (8), further comprising:

confirmation means for mutually confirming the order for the printing between the terminal of the second party and that of the selected first party when the finalized information is input by the input means.

This arrangement provides an additional advantage in that both the publisher and the selected printing company can mutually confirm the conditions for the operation of printing copies of the printed matter at the time of order placement to eliminate any possible cross-purposes that can arise between the publisher and the printing company in the future, in addition to the advantages of (7) and (8) above.

(10) The system according to (8), wherein

a local data base of each of the first parties storing the attribute information of the first party is connected to the computer network; and

the detecting operation of the detection means is started after the data base is synchronized with each of the local data bases in response to the input of information relating to the printing requirements.

This arrangement provides an additional advantage in that any possible cross-purposes that can arise between the publisher and the printing company can be eliminated in advance and the publisher can always obtain updated information relating to the printing companies because the data base is synchronized with each of the local data bases before the detecting operation, in addition to the advantages of (8) above.

(11) The system according to one of (8) to (10), wherein

the attribute information includes at least one of information relating to the printing skill specific to each of the printing companies of the first party and information relating to the printing workload of each of the printing companies of the first party.

This arrangement provides an additional advantage in that the basic questions of the publisher including “if the required level of printing quality is ensured” and “if the delivery deadline is observed” can be answered because information relating to the printing skill specific to each of the printing companies and the printing workload of each of the printing companies are stored in the data base, in addition to the advantages of (8), (9) and (10) above.

(12) The system according to one of (7) to (11), wherein

the information relating to the printing requirements input include at least one of information relating to the quality requirements of the printed matter and information relating to the delivery deadline of the copies of the printed matter.

This arrangement provides an additional advantage in that the publisher can specify the basic questions of the publisher including “if the required level of printing quality is ensured” and “if the delivery deadline is observed” as conditions for detection when the publisher detects a desired printing company, in addition to the advantages of (7), (8), (9), (10) or (11) above.

(13) An information resource to be utilized in a printing ordering system commonly used for a printed matter by a first party engaged in printing printed matters to be published and a second party engaged in publishing the printed matters by utilizing a computer network, the information resource being connected to the computer network, the information resource comprising:

means for receiving information relating to the request for printing the printed matter including printing requirements for the printed matter from the terminal connected to the computer network and used by the second party to input the printing requirements;

means for detecting the first party as judged to be qualified to meet the printing requirements on the basis of the information relating to the printing requirements input to the terminal; and

means capable of providing information relating to the first party to the terminal by way of the computer network.

With this arrangement, when a publisher intending to publish a printed matter places an order for printing copies of the printed matter with a printing company, the publisher can easily detect a printing company that is qualified and can meet the printing requirements of the publisher by means of a computer network so that the publisher can place the order for printing copies of the printed matter with the printing company efficiently and economically to a great advantage of the both parties.

(14) The resource according to (13), further comprising:

a data base storing attribute information relating to the printing ability specific to each of a plurality of candidate first parties.

This arrangement provides an additional advantage in that a desired printing company can be selected from a plurality of candidate printing companies on the basis of the printing ability of each of the candidate printing companies, in addition to the advantages of (13) above.

(15) The resource according to (14), wherein

a local data base of each of the first parties storing the attribute information on the first party is connected to the computer network; and

the detecting operation is started after the data base is synchronized with each of the local data bases in response to the input of information relating to the printing requirements.

This arrangement provides an additional advantage in that any possible cross-purposes that can arise between the publisher and the printing company can be eliminated in advance and the publisher can always obtain updated information relating to the printing companies because the data base is synchronized with each of the local data bases before the detecting operation, in addition to the advantages of (14) above.

(16) The resource according to (14) or (15), wherein

the attribute information includes at least one of information relating to the printing skill specific to each of the printing companies of the first party and information relating to the printing workload of each of the printing companies of the first party.

This arrangement provides an additional advantage in that the basic questions of the publisher including “if the required level of printing quality is ensured” and “if the delivery deadline is observed” can be answered because information relating to the printing skill specific to each of the printing companies and the printing workload of each of the printing companies is stored in the data base, in addition to the advantages of (14) or (15) above.

(17) The resource according to one of (13) to (16), wherein

the information relating to the printing requirements input include at least one of information relating to the quality requirements of the printed matter and information relating to the delivery deadline of the copies of the printed matter.

This arrangement provides an additional advantage in that the publisher can specify the basic questions of the publisher including “if the required level of printing quality is ensured” and “if the delivery deadline is observed” as conditions for detection when the publisher detects a desired printing company, in addition to the advantages of (13), (14), (15) or (16) above.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A printing ordering method to be commonly used for a printed matter by a first party engaged in printing printed matters to be published and a second party engaged in publishing the printed matters by utilizing a computer network, said method comprising:
a first step for said second party to input information relating to the request for printing said printed matter including printing requirements to the terminal connected to said computer network;
a second step of detecting said first party as judged to be qualified to meet the printing requirements input in said first step from an information resource storing information relating to said first party and connected to said computer network;
a third step of outputting and displaying the information relating to the detected first party in said second step on the terminal of said second party; and
a fourth step for said second party to input finalized information to be used for selecting said first party as the order receiving party on the basis of the information relating to said first party output and displayed in said third step.

2. The printing ordering method according to claim 1, wherein
said information resource contains a data base storing attribute information relating to the printing ability specific to each of a plurality of candidate first parties; and
said first party is detected in said second step from said data base on the basis of said attribute information and the information relating to the input printing requirements.

3. The printing ordering method according to claim 1, further comprising:
a fifth step of mutually confirming the order for the printing between the terminal of the second party and that of the selected first party after selecting the first party in said fourth step.

4. The printing ordering method according to claim 2, wherein
a local data base of each of said first parties storing the attribute information of the first party is connected to said computer network; and
the detecting operation of said second step is started after said data base is synchronized with each of said local data bases in response to the input of information relating to the printing requirements in said first step.

5. The printing ordering method according to claim 2, wherein
said attribute information includes at least one of information relating to the printing skill specific to each of the printing companies of the first party and information relating to the printing workload of each of the printing companies of the first party.

6. The printing ordering method according to claim 1, wherein
the information relating to the printing requirements input in said first step include at least one of information relating to the quality requirements of said printed matter and information relating to the delivery deadline of the copies of said printed matter.

7. A printing ordering system to be commonly used for a printed matter by a first party engaged in printing printed matters to be published and a second party engaged in publishing the printed matters by utilizing a computer network, said system comprising:
a terminal connected to said computer network so as for said second party to input information relating to the request for printing said printed matter including printing requirements for said printed matter; and
an information resource connected to said computer network and adapted to provide information relating to said first party to said terminal in response to the printing requirements input to said terminal; wherein
said information resource includes:
detection means for detecting said first party as judged to be qualified to meet the printing requirements on the basis of the information relating to the printing requirements input to said terminal; and
said terminal includes:
display means for outputting and displaying the information relating to the first party detected by said detection means; and
input means to be used by said second party to input finalized information to be used for selecting said first part as order receiving party on the basis of the information relating to said first party output and displayed by said display means.

8. The printing ordering system according to claim 7, wherein
said information resource contains a data base storing attribute information relating to the printing ability specific to each of a plurality of candidate first parties; and
said detection means detects said first party from said data base on the basis of said attribute information and the information relating to the input printing requirements.

9. The printing ordering system according to claim 7, further comprising:
confirmation means for mutually confirming the order for the printing between the terminal of the second party and that of the selected first party when said finalized information is input by said input means.

10. The printing ordering system according to claim 8, wherein
a local data base of each of said first parties storing the attribute information of the first party is connected to said computer network; and
the detecting operation of said detection means is started after said data base is synchronized with each of said local data bases in response to the input of information relating to the printing requirements.

11. The printing ordering system according to claim 8, wherein
said attribute information includes at least one of information relating to the printing skill specific to each of the printing companies of the first party and information relating to the printing workload of each of the printing companies of the first party.

12. The printing ordering system according to claim 7, wherein
the information relating to said printing requirements input include at least one of information relating to the quality requirements of said printed matter and information relating to the delivery deadline of the copies of said printed matter.

13. An information resource to be utilized in a printing ordering system commonly used for a printed matter by a first party engaged in printing printed matters to be published and a second party engaged in publishing the printed matters by utilizing a computer network, said information resource being connected to said computer network, said information resource comprising:
means for receiving information relating to the request for printing said printed matter including printing requirements for said printed matter from the terminal connected to said computer network and used by said second party to input said printing requirements;
means for detecting said first party as judged to be qualified to meet the printing requirements on the basis of the information relating to the printing requirements input to said terminal; and
means capable of providing information relating to said first party to said terminal by way of said computer network.

14. The information resource according to claim 13, further comprising:
a data base storing attribute information relating to the printing ability specific to each of a plurality of candidate first parties.

15. The information resource according to claim 14, wherein
a local data base of each of said first parties storing the attribute information on the first party is connected to said computer network; and
the detecting operation is started after said data base is synchronized with each of said local data bases in response to the input of information relating to the printing requirements.

16. The information resource according to claim 14, wherein
said attribute information includes at least one of information relating to the printing skill specific to each of the printing companies of the first party and information relating to the printing workload of each of the printing companies of the first party.

17. The information resource according to claim 13, wherein
the information relating to the printing requirements input include at least one of information relating to the quality requirements of said printed matter and information relating to the delivery deadline of the copies of said printed matter.
